(19) United States
(12) Patent Application Publication
(10) Pub. No.: US 2004/0024719 A1
(43) Pub. Date: Feb. 5, 2004

(54) System and method for scoring messages within a system for harvesting community kowledge

(76) Inventors: Eytan Adar, Palo Alto, CA (US); Rajan Mathew Lukose, Palo Alto, CA (US); Joshua Rogers Tyler, Stanford, CA (US); Caesar Sengupta, Los Altos, CA (US)

Correspondence Address: HEWLETT -PACKARD COMPANY, Intellectual Property Administration, P.O. Box 272400, Fort Collins, CO, 80527-2400, US

(21) Appl. No.: 10/210,593

(22) Filed: Jul. 31, 2002

(51) Int. Cl. G06F 17/00; G06N 5/02; G06F 15/18; G06F 7/00; G06F 17/30

(52) U.S. Cl. 706/12; 706/46; 707/3

(57) ABSTRACT

A system and method for scoring messages within a privacy-preserving knowledge management is disclosed. The method of the present invention discloses, generating a message including a set of data items within a message field; transmitting the message from a sending client to a set of receiving clients; generating a receiving client profile on one of the receiving clients; extracting the data items from the profile; and scoring the data items in the message with respect to the data items in the profile. Alternatively the method can include, generating a receiving client profile on at a receiving client; storing the profile on the computer; receiving a message including a set of data items within a message field; extracting the data items from the profile; and scoring the data items in the message with respect to the data items in the profile. The system of the present invention, discloses means for implementing the method.

### CROSS-REFERENCE TO CO-PENDING APPLICATIONS

This application relates to and incorporates by reference co-pending U.S. patent applications: Ser. No. 10/093,658, entitled “System And Method For Harvesting Community Knowledge,” filed on Mar. 7, 2002, by Adar et. al.; and Ser. No. 10/106,096, entitled “System And Method For Profiling Clients Within A System For Harvesting Community Knowledge,” filed on Mar. 25, 2002, by Adar et. al. These related applications are assigned to Hewlett-Packard Co. of Palo Alto, Calif.

### BACKGROUND OF THE INVENTION

1. Field of the Invention

The present invention relates generally to systems and methods for information sharing and knowledge management, and more particularly for scoring messages within a system for harvesting community knowledge.

2. Discussion of Background Art

Satisfying information needs in a diverse, heterogeneous information environment is challenging. In order to even begin the process of finding information resources or answers to questions, individuals typically must know either where to look, or whom to ask. This is often a daunting task, especially in large enterprises where many of the members will not know each other, nor be aware of all the information resources potentially at their disposal. In such situation, individuals often present their questions and messages in a somewhat haphazard manner to others who may or may not be able to answer them. When the wrong person is asked the question, or presented with the message, that person's valuable time is wasted. This is equivalent to receiving “spam” in an electronic mail system.

Current systems for storing information and/or organizational expertise include Knowledge Databases (K-bases), such as document repositories and corporate directories, and Knowledge Management systems, which rely on users to explicitly describe their personal information, knowledge, and expertise to a centralized K-base.

FIG. 1 is a dataflow diagram of a conventional knowledge management system 100. In a typical architecture, information providing users 102 explicitly decide what descriptive information they provide to a central database 104. An information seeking user 106 then performs a query on the central database 104 in order to find an information provider who perhaps may be able to answer the seeker's question.

There are several significant problems with such systems. Knowledge management systems, like that shown in FIG. 1, require that information providers spend a significant amount of time and effort entering and updating their personal information on the central database 104. For this reasons alone, such systems tend to have very low participation rates. In addition, even those information providers, who take time to enter and update this information, may misrepresent their personal information or level of knowledge and expertise be it willfully or not. Furthermore, they may neglect or be unable to reveal much of their tacit knowledge within their personal description. Tacit knowledge is knowledge a user possesses, but which the user either does not consider important enough to enter, or which they may not even be consciously aware that they know.

Because of the inaccuracy and/or incompleteness of such personal information, information seekers, even after all of their searching efforts, may still find their questions left unanswered, perhaps because the “expert” they identified was actually not an expert and thus could only provide shallow or irrelevant responses. Similarly, even information seekers who discover the existence of a relevant K-base may be required to formulate queries which are so complex that they either can not or will not bother to perform a proper search.

A second significant problem with knowledge management systems is the information provider's lack of privacy with respect to their personal information stored on the central database 104. No matter what agreements a knowledge management system's central database 104 provider has made with the user, the fact remains that the central database 104 provider still has the user's personal information, which means that that personal information is out of the direct control of said user. As a result, information providers may be unwilling to reveal much about themselves in the presence of a risk that their privacy would be violated. In such systems, the provider must pre-screen all information to be revealed, in order to make sure that the information provided does not contain information which the user would not be comfortable with others having access to. The resulting high participation costs often results in profiles that are stale and lack richness.

Another problem with such systems, is their lack of anonymity. Information seekers and providers cannot remain anonymous while performing queries or asking questions. As such, they may not perform a search, as a question, or wholeheartedly reveal their knowledge about a particular topic in their response to another user's question.

All of the above problems lead to free-riding by many of those using such conventional knowledge management systems. Free-riders are those who benefit from information resources but who do not themselves provide information for the benefit of others. Free-riding tends to make all users worse off, since a knowledge management system's and K-base's value depends upon the richness and fidelity of each users' contributions.

A fourth problem is cost. Conventional centralized systems require the installation of additional hardware dedicated to the knowledge management system and do not make use of otherwise unutilized resources such as the user's own personal computer.

Collaborative filtering techniques also have similar problems. Collaborative filtering is a tool for selectively presenting users with information recommendations based on the collective wisdom of the participant users. Generally these systems require users to actively mark incoming information as relevant or not relevant to their interests. A central system manages this information and attempts to group individuals with similar interests (as expressed by the ratings they assign to pieces of information). Users who seek knowledge in are then directed to information that members like them have indicated as relevant. Due to their centralized nature, these systems lack many privacy features and require heavy active participation by individuals. For this reason collaborative filtering systems frequently do not have access to rich profiles. Additionally, the information that is filtered may not address specific information needs and the user must then wade through the information or perform additional searches and may still find no answer.

In response to the concerns discussed above, what is needed is a system and method for harvesting community knowledge that overcomes the problems of the prior art.

### SUMMARY OF THE INVENTION

The present invention is a privacy-preserving system and method for knowledge management. A first embodiment of the method of the present invention includes the elements of, generating a message including a set of data items within a message field; transmitting the message from a sending client to a set of receiving clients; generating a receiving client profile on one of the receiving clients; extracting the data items from the profile; and scoring the data items in the message with respect to the data items in the profile. A second embodiment of the method of the present invention adds to the first embodiment the elements of, generating a first expertise vector magnitude equal to a relative term frequency of the data item in the message; generating a first expertise vector magnitude equal to a relative term frequency of the data item in the profile; and comparing the first and second expertise vector magnitudes. A third embodiment of the method of the present invention adds to the first and second embodiments the elements of, generating a message, having a set of filtering criteria; assigning a first filter score to a filtering criteria within the set, if that filtering criteria within the set is found within the profile; assigning a second filter score to that filtering criteria within the set, if that filtering criteria is not found within the profile; and calculating an overall score from the expertise vectors and the filter scores. A fourth embodiment of the method of the present invention includes the elements of, generating a receiving client profile on at a receiving client; storing the profile on the computer; receiving a message including a set of data items within a message field; extracting the data items from the profile; and scoring the data items in the message with respect to the data items in the profile. The system of the present invention, includes all means for implementing the method.

These and other aspects of the invention will be recognized by those skilled in the art upon review of the detailed description, drawings, and claims set forth below.

### BRIEF DESCRIPTION OF THE DRAWINGS

FIG. 1 is a dataflow diagram of a conventional system for knowledge management;

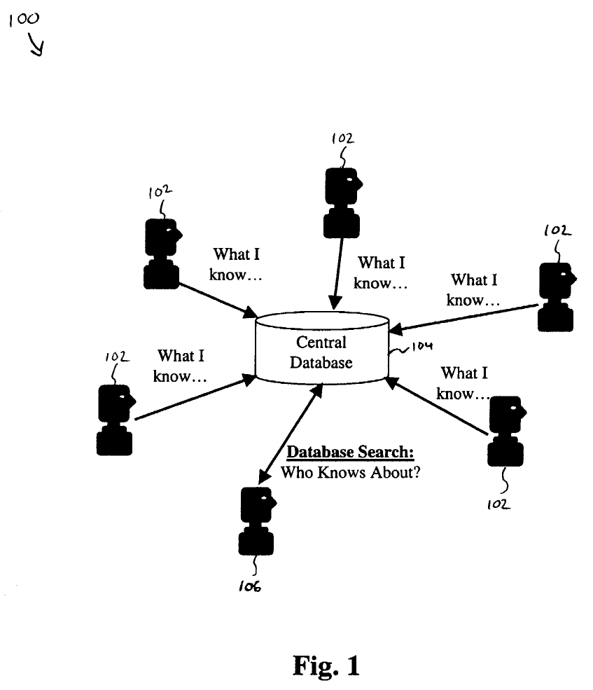

FIG. 2 is a dataflow diagram of one embodiment of a system for profiling clients within a system for harvesting community knowledge;

FIG. 3 is a flowchart of one embodiment of a method for harvesting community knowledge;

FIG. 4 is a flowchart of one embodiment of a method for profiling clients within the method for harvesting community knowledge;

FIG. 5 is a flowchart of one embodiment of a method for message generation within the method for harvesting community knowledge;

FIG. 6 is a pictorial diagram of one embodiment of a “Find An Expert” message within the system;

FIG. 7 is a flowchart of one embodiment of a method for scoring messages within the method for harvesting community knowledge; and

FIG. 8 is a pictorial diagram of one embodiment of a “Messages In-Box” window within the system.

### DETAILED DESCRIPTION OF THE PREFERRED EMBODIMENT

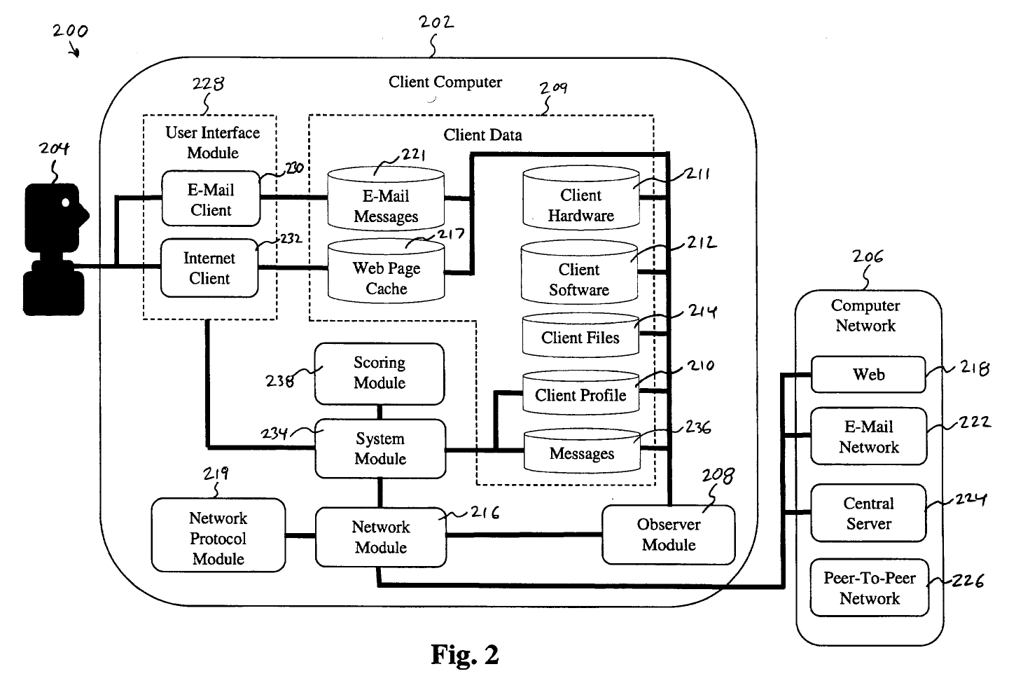

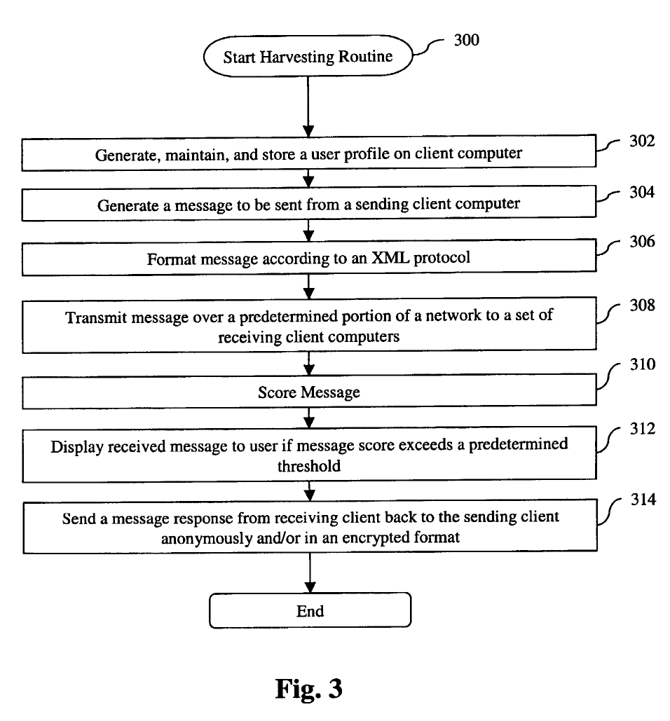

FIG. 2 is a dataflow diagram of one embodiment of a system 200 for harvesting community knowledge. FIG. 3 is a flowchart of one embodiment of a method 300 for harvesting community knowledge. FIGS. 2 and 3 are herein discussed together. The system 200 includes a client computer 202 under the control of a user 204, and connected to a computer network 206. The client 202 both sends and receives messages respectively to and from other client computers and information sources via the network 206. When a client computer generates and sends a message such client computer is herein alternately called a sending client, and when a client computer receives a message, such client computer is herein alternately called a receiving client. Preferably all client computers on the network include the same functionality, which is now described with respect to the client computer 202, however some receiving clients may not currently have the present invention's software installed.

User Profiling

User profiling by the present invention, enables the system 200 to capture historical information about the user 204, as well as real-time information as the user 204 goes about their daily digital business. This knowledge is expressed indirectly in the user's 204 behavior and data stored on the client computer 202 and from the user 204 and client computer 202 interactions with the network 206.

The present invention uses an observer module 208 to automatically compile and store user profile information in a client profile 210. The client profile 210 is generated using systematic, objective and repeatable methods which can be adjusted and modified to suit any number of user environments and/or information processing end goals. Since the client profile 210 is automatically created, the user 204 is relieved from the arduous task of having to manually build their own profile. This dramatically reduces participation costs for all users of the present invention, while ensuring that the user's profile is constantly kept up to date.

Preferably, more than one data source or set of data items are profiled in order to generate a multi-dimensional understanding of the user's 204 knowledge and that the resultant user profile is of a high quality. This is because singular sources of data, such as e-mail, tend not to fully reflect a user's interests and expertise. Also, since user profiles are preferably generated on each user's own computer 202, no new hardware resources need be purchased in order to implement the present invention.

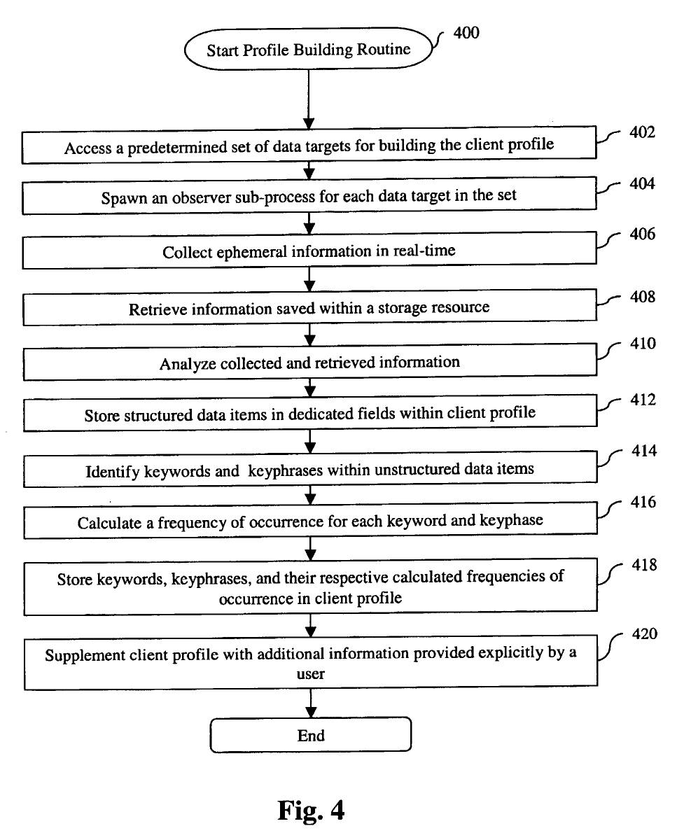

The method 300 begins in step 302 with the observer module 208 generating and maintaining the client profile 210 on the client computer 202. Step 302 is now described in more detail in FIG. 4.

FIG. 4 is a flowchart of one embodiment of a method 400 for profiling clients within the method 300 for harvesting community knowledge. The profiling method 400 begins in step 402 wherein the observer module 208 accesses a predetermined set of data targets for building the client profile 210. The set of data targets are preferably selected to provide a robust source of data for processing into a meaningful and versatile client profile 210. The data targets include information stored on the client computer 202, information accessible over the network 206, as well as which can be obtained by monitoring the user's 204 activities on the computer 202 and over the network 206.

Next in step 404, the observer module 208 spawns an observer sub-process for each data target in the set. Depending upon the data target, some of the sub-process must, in step 406, collect certain ephemeral information in real-time. Such ephemeral information may include temporarily cached data which is deleted after the data target terminates operations, network traffic information, as well as information received by the data target, such as e-mails or messages, which the user 204 subsequently deletes before said information can be permanently saved. However, information otherwise saved within a storage resource may be retrieved as needed, in step 408.

In step 410, the observer 208 analyzes the collected and retrieved information using data mining techniques. In step 412, structured data items within the collected and/or retrieved information, such as e-mail addresses or URLs, are stored in dedicated fields within the client profile 210. Unstructured data items within the collected and retrieved information, such as pure text, however are first statistically analyzed. The statistical analysis includes, first identifying a set of keywords and a set of key phrases within the unstructured data items, in step 414, and then, calculating a frequency of occurrence for each keyword and key phrase within the data item, in step 416. In step 418, the keywords, key phrases, and their respective calculated frequencies of occurrence are then stored in the client profile 210. If the keyword or key phrase already exists within the client profile 210, their frequencies of occurrence are combined. Preferably, the unstructured data itself is not stored within the client profile 210. The client profile 210 data structure is preferably that of a relational database upon which queries can be easily performed.

Thus the present invention's observer 208, by collecting, retrieving, and analyzing, information from the data targets, effectively captures the user's 204 tacit knowledge, which the user 204 themselves may not even be conscious of having knowledge, expertise, or an interest in.

In step 420, the client profile 210 may at the user's 204 discretion be supplemented with additional information provided explicitly by the user 204.

In order to maximize the user's 204 privacy and thereby encourage broad user participation within the information market, the client profile 210 is preferably stored only on the client computer 202, however the profile 210 may also be stored remotely either in encrypted or password protected form and viewable only by the user 204. Also to toward this goal, the user 204 is also preferably given an option of erasing their client profile 210, or having the observer 208 rebuild a new client profile for the user 204. A high degree of user privacy encourages users to permit the system 200 to build very rich user profiles which go far beyond those users would otherwise voluntarily disclose to a central database.

The following data targets are preferably included within the predetermined set of data targets mentioned in step 402. Specific preferred processing techniques for each of these data targets are also discussed. Those skilled in the art however will recognize that many additional data targets and processing techniques may also be employed and that a particular mix of data targets and processing techniques which yield a best client profile may vary with the set of users and network configuration to which the present invention is applied.

Message Data Targets:

Message data targets include messages routed over the peer-to-peer 226 and central server 224 networks, as well as e-mail messages routed over the e-mail network 222. E-mail is one of the most fundamental and prevalent forms of communication today and as such is considered to be a good source of user profile information. E-mail sub-processes within the observer module 208 access the e-mail messages 221 transmitted and received by the e-mail client 230 over the e-mail network 222.

Structured data items from the e-mail which are preferably stored in the client profile 210 include: the email addresses, domains, and identities for the sender and all of the recipient's; and message timestamps.

Unstructured e-mail data, consisting mainly of the body of an e-mail message, are processed according to the statistical techniques discussed above, into keywords, key phrases, and frequencies of occurrence before being stored in the client profile 210.

Behavioral data preferably stored include: which e-mails or messages the user 204 reads, stores, deletes, and/or ignores. Those e-mails or messages which the user 204 reads or stores becomes part of the user's 204 “positive-profile.” Whereas those e-mails and messages which the user 204 either deletes or ignores becomes part of the user's 204 “negative-profile.”

Messages processed by either the peer-to-peer 226 or central server 224 networks are similarly processed and added to the client profile 210.

Information Browsing Data Targets:

Information browsing data targets monitored by sub-processes within the observer module 208 include: data files transmitted to or downloaded from the peer-to-peer 226 and central server 224 networks, client files 214 viewed, modified, or deleted by the user, such as word processing, spreadsheet and other files; as well as web page information routed over the web 218 by the internet client 232 into a web page cache 217.

Structured data items which are preferably stored in the client profile 210 include: URLs stored in the user's 204 bookmark and/or favorites file; web pages visited by the user or stored in the web page cache 217; identifying information from client files 214 accessed by the user 204; and time and frequency of visitation to said web pages or client files 214.

Unstructured data, consisting mainly of the body of the web pages visited and client files 214 accessed by the user, is also processed according to the statistical techniques discussed above, into keywords, key phrases, and frequencies of occurrence before being stored in the client profile 210.

Behavioral data preferably stored include: web surfing patterns and browsing behavior.

Installed Hardware and Software Data Targets:

Installed hardware and software data targets monitored by sub-processes within the observer module 208 include the client hardware 211 and software 212 installed on the computer 202. The client software 212 includes the e-mail client 230 and the internet client 232.

Structured data items which are preferably stored in the client profile 210 include: hardware 211 device information; software 212 installation and operational information, available in part from registry files within the computer 202; and dates of installation for each hardware device and software process.

Behavioral data preferably stored include: user interactions with the installed hardware 211 and software 212, such as frequency of use or reconfiguration.

Other Data Targets:

Other information sources which the observer 208 may access in order to build the client profile 210 include: user information stored in remote enterprise directories and on the central server 224. For example, user information stored using a Lightweight Directory Access Protocol (LDAP) can be accessed by the observer module 208 over the network 206. The user information stored on the LDAP server may include the user's department number, location, and other human resources information.

Message Generation

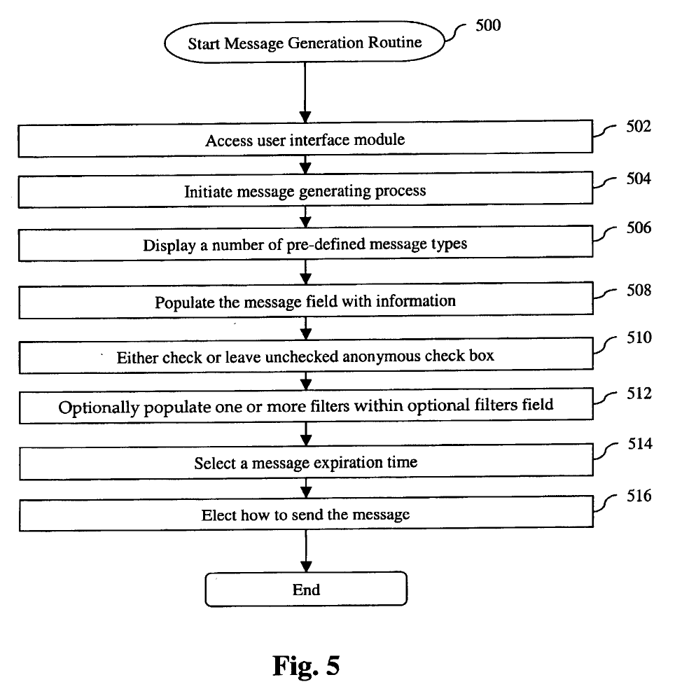

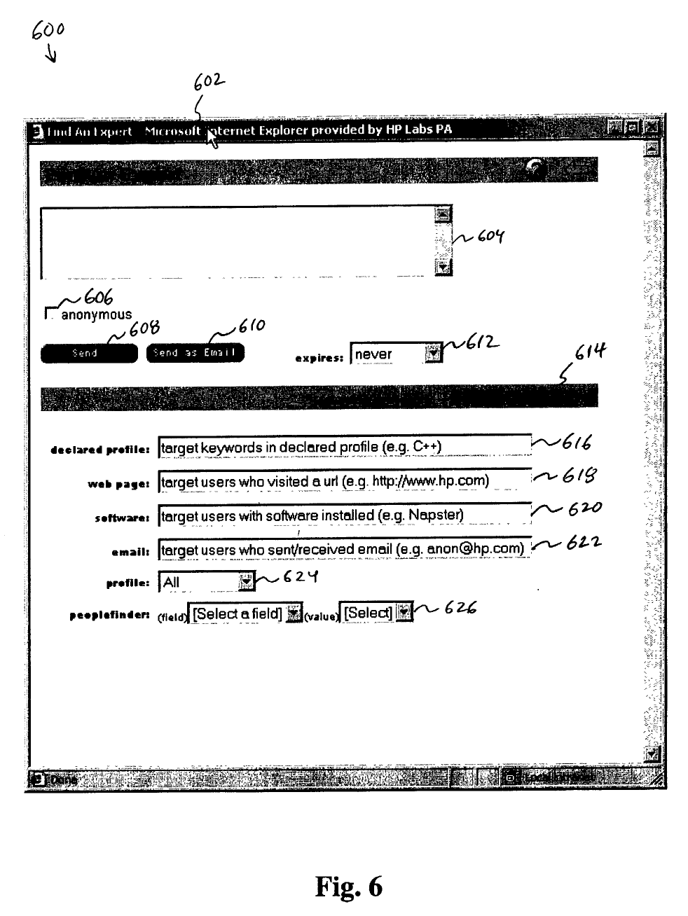

Next to be described is a system and method for generating messages in step 304 using the present invention. Messages are herein defined to include a wide variety of communications known to those skilled in the art, including any communication seeking, sending, and/or culling information from an information market. Thus messages can include questions, announcements, and/or information processing routines. Step 304 is now described in more detail in FIGS. 5 and 6 which are now discussed together.

FIG. 5 is a flowchart of one embodiment of a method for 500 message generation within the method for harvesting community knowledge. The method 500 begins in step 502 where the user 204 accesses a user interface module 228. The user interface module 228 preferably includes a set of software modules for interfacing with the user 204. Such modules at a minimum include the e-mail client 230, which stores a predetermined set of e-mail messages 221, and the Internet client 232, which stores information in the web page cache 217. These two modules 230 and 232 provide the user 204 with alternate ways of using the present invention and preferably, both contain similar functionality, such as text windows and folders for storing messages both sent and received.

Through the user interface module 228, the user 204 in step 504 initiates the message generating process, such as by clicking on an “Ask a Question” button in a toolbar within the user interface. In response, the user interface module 228 in step 506 displays a number of pre-defined message types to the user 204. One representative pre-defined message type is called “Find an Expert.”

FIG. 6 is a pictorial diagram 600 of one embodiment of a “Find an Expert” message 602 within the system 200. The find an expert message 602 includes a message field 604, an anonymous check box 606, a send button 608, a send as e-mail button 610, an expires field 612, and an optional filters field 614.

In step 508, the user 204 populates the message field 604 with information the user believes will help narrow the field of receiving clients (i.e. “experts”) to which the message 602 is sent. In step 510, the user 204 either checks or leaves unchecked the anonymous check box 606. If left unchecked, information identifying the user 204 will be sent with the message 602 over the network 206 to all receiving clients. However, if the anonymous check box 606 is checked, the message will be sent only over a peer-to-peer network 226, using randomization, without any information explicitly identifying the user's identity. Thus, user's have control over revealing their identity to other users on the network 206.

Next in step 512, the user optionally populates one or more filters within the optional filters field 614. These filters permit the user 204 to selectively target the message 602 to an even narrower set of receiving clients satisfying criteria which the user has populated the filters with. Filters can preferably be defined for any of the “structured” data items, “unstructured” data items, and “behavioral” information culled from any data target and stored in the client profile 210, as was discussed above with respect to FIG. 4.

In the example show in FIG. 6, the optional filters 614 include: a declared profile field 616 into which the sending client can enter keywords and key-phrases; a web page field 618 into which the sending client can enter web-site URLs; a software field 620 into which the sending client can enter a particular software program which a receiving client must have installed; an e-mail field 622 into which the sending client can enter addresses or domains which a receiving client must have either sent or received an e-mail messages from; a profile field 624 for indicating which portions of a receiving client's client profile are to be evaluated with respect to the words in the message field 604 as well as the filtering criteria 614 (for example, in one embodiment the profile field can be set to either “All” of the client profile, “Only E-Mail” within the client profile, or “Only indexed web pages within the client profile); and a people finder field 626 for requiring that the receiving client have a particular job title, sit in a particular location, or match any of the other LDAP criteria. Of course, the filtering fields shown in FIG. 6 include only a portion of all the different filters that can be created, in various embodiments of the present invention.

Some examples of messages that can be composed by sending clients using the expert message 602 include: Message: Can I bounce an idea off you? Filtering Criteria: people who regularly view www.bluetooth.com; Message: Is this a good journal? Filtering Criteria: people who regularly view a particular Web page of a particular journal; Message: Can you help me with my Java Swing problem? Filtering Criteria: people who have recently viewed the Sun Java documentation for the Swing library?; Message: Can you help us get a meeting? Filtering Criteria: people who send email regularly to X; Message: Can you help me with my travel plans? Filtering Criteria: people who have book-marked a Web page on making train reservations in India.

Thus fields within the predefined message types allow sending clients to define a unique “expertise” which the sending client wants all receiving clients presented with the message to possess.

In step 514, the sending client 202 selects a value for an expires field 612. The expires field 612 contains time period information for controlling transmission of the message 602 over the network 206. Depending upon the particular implementation of the present invention, settings in the expires field 612 may either: place a time limit on a number of times a network module 216, or some other resource on the network 206, such as a dedicated server, transmits the message 602 over the network 206; or place a time limit on how long the user 204 will permit receipt of responses to the message 602 from other users. For example, messages which invite others to a meeting could have their expires field set to the start time of the meeting.

In step 516 the sending client elects to transmit the message 602 either over the peer-to-peer 226 network, by clicking on a send button 608, or over the e-mail network 222, by clicking on a send as e-mail button 610.

After a message has been generated it is preferably assigned a globally unique identifier and stored in a messages database 236. The network module 216 periodically scans the message database 236 for new messages generated by the user 204. Then in step 306, a network protocol module 219 formats the new message according to an XML (Extensible Markup Language) protocol for transmission by the network module 216 over the network 206. Both a client computer sending the message and a client computer receiving the message must be apprised of the particular XML protocol used to format the message, in order for communication to occur.

Message Transmission

Next in step 308, the network module 216 transmits the message over a predetermined portion of the computer network 206. As mentioned above, when the computer client 202 transmits a message over the network 206 it is called a sending client, while when the computer client 202 receives a message over the network 206 it is called a receiving client. Thus in normal operation, all client computers function as both sending and receiving clients.

While messages transmitted over the peer-to-peer network 226 achieve a high level of anonymity, many messages will likely be transmitted over the e-mail network 222 or displayed on a web 218 site in order to advertise the present invention and thereby build-up the peer-to-peer network 226.

However, regardless of over which network portion the message is sent, each receiving client having the present invention installed stores a copy of the XML encoded message in their respective messages database.

Message Scoring

For purpose of the discussion to follow, functionality within the client computer 202 for scoring received messages is discussed as if the client computer 202 was one of the receiving client computers. Such a context switch is appropriate because preferably each client computer contains a complete and self contained version of the present invention's software.

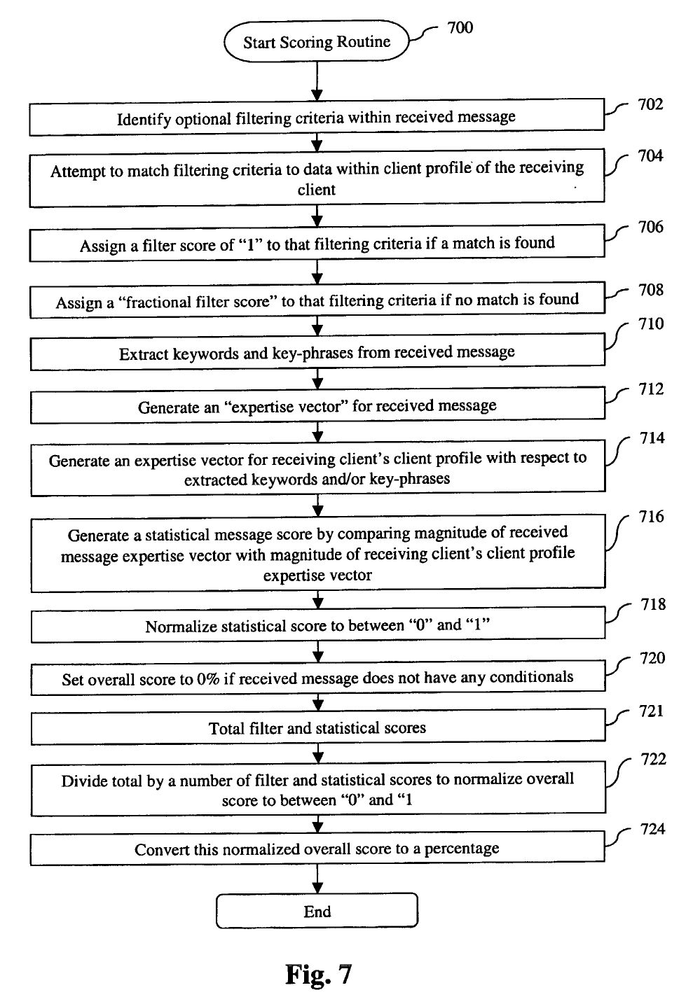

In step 310, the system module 234 within the receiving client computer 202 retrieves, and commands a scoring module 238 to score, newly received messages stored in the messages database 236. Step 310 is now described in more detail in FIG. 7.

FIG. 7 is a flowchart of one embodiment of a method 700 for scoring received messages within the method for harvesting community knowledge. Messages are scored using a series of “rules” herein also labeled as “conditionals.” Conditionals come in two main varieties, Boolean or Quasi-Boolean and Fuzzy. Boolean and Ouasi-Boolean conditionals are encoded as XML in the received message and are used to generate a “filter score” and return a score of “1” if true or “0” if false. Quasi-Boolean conditionals, however, return a small fractional score, such as “0.1,” if false. Each piece of XML in a message can be evaluated by a Java object. Fuzzy conditionals return a decimal score anywhere between “1” and “0” and are used to generate a “statistical score.” Scoring is performed by the scoring module 238 by comparing structured and unstructured data within a received message with structured and unstructured data stored in the receiving client's 204 client profile 210. New conditionals can easily be added.

Filter Score

Filters can be either Boolean or Quasi-Boolean conditionals, and as discussed above with respect to FIGS. 5 and 6, sending clients may insert one or more optional filters 614 into a message. In alternate embodiments, however, the filters 614 may be required. These optional filters 614 define “structured” data items and/or “keywords/key-phrases” which the sending client prefers the receiving client to meet, before the message is displayed to the receiving client. So in step 702, the scoring module 238 identifies any optional filtering criteria within the received message. Next is step 704, the scoring module 238 attempts to match the optional filtering criteria to data within the client profile 210 of the receiving client. In step 706, if a match is found, a filter score of “1” is assigned to that filtering criteria. In step 708, if a match is not found, a “fractional filter score” is assigned to that filtering criteria. Thus, in the preferred embodiment, filtering criteria which is not satisfied by the receiving client, while substantially lowering the message's overall score, does not cause the message to have a 0% overall score, as will be discussed below.

In an alternate embodiment of the present invention, if a match is not found a filter score of “0” is assigned to that filtering criteria. Such an embodiment is not preferred, since the sending client may include errors in the message's filtering criteria which were completely unintentional, such as a typo, which could have harsh consequences on an “overall message score.” As will be discussed with respect to the “Overall Score” below, such errors could cause the message to have an Overall Score of 0%, when perhaps the overall score should have been much higher.

Those skilled in the art will recognize that other filter scoring techniques may also be used.

Statistical Score

While the filter score compare the receiving client's client profile 210 to the sending client's filtering criteria, the statistical score is a fuzzy conditional which compares the receiving client's client profile 210 to both the sending client's filtering criteria and content within the message field 604.

Received messages are preferably scored using a predetermined set of statistical information retrieval techniques, such as linguistic analysis/scoring, known to those skilled in the art. Information retrieval techniques are commonly known to be used for accessing and analyzing large blocks of data and then extracting all or selected portions of such data according to a wide variety of methods.

To begin, the scoring module 238 extracts keywords and key-phrases from the received message, in step 710. Then, in step 712, the scoring module 238 generates a “expertise vector” for the received message 602. The expertise vector's magnitude equals a relative term frequency of each of the keywords and/or key-phrases within the message 602.

In step 714, the scoring module 238 then generates an expertise vector, and magnitude thereof, for the receiving client's client profile 210 using the extracted keywords and/or key-phrases. The scoring module 238 primarily analyzes the receiving client's client profile 210 in order to calculate this expertise vector, however, the scoring module 238 may also analyze various files or caches stored on the recipient's client computer 202.

Then, in step 716, the scoring module 238 generates the statistical message score by comparing the magnitude of the received message expertise vector with the magnitude of the receiving client's client profile expertise vector for each key-word and key-phrase. This statistical message score is equal to a “distance” or “angle” between these two expertise vectors. Finally, in step 718, the statistical score is normalized to between “0” and “1.”

In an alternate embodiment of the present invention, the scoring module 238 calculates what percentage of the data targets indexed within the receiving client's 202 client profile 210 contain the received message's keywords and/or key-phrases in order to generate the receiving client's client profile expertise vector.

In another alternate embodiment, the scoring module 238 may simply check to see if the keywords and/or key-phrases within the received message are also within the client profile 210 of the receiving client. Statistical scoring can also benefit from a variety of querying techniques, such as a nearness of one keyword to another within a data item such as a document, and/or a percentage of data items which score highly with respect to the received message's keywords and/or key-phrases. For example, while a particular receiving client's client profile may have indexed a data target whose expertise vector perfectly matches that of the received message, all of the receiving client's other data targets may have a polar opposite expertise vector with respect to the received message. Such a receiving client would perhaps not be a very good candidate for receiving the message, and thus the statistical score would be adjusted lower.

In another embodiment, expertise vectors may be weighted using locally and globally known information, such as frequently occurring terms, such as when Inverse Document Frequency (IDF) weighting techniques are uses. Those skilled in the art will recognize other statistical scoring techniques as well.

Overall Score

An overall score for the received message with respect to the receiving client is then calculated by combining the filter and the statistical scores, discussed above. Those skilled in the art will recognize that there are many different ways to combine theses scores of which only a few embodiments are now discussed. Regardless of how the overall score is calculated, the overall score is meant to represent a percentage likelihood (on a 0% to 100% scale) that the receiving client will be able to respond to the received message with a correct and/or useful answer.

One embodiment in now presented. In step 720, the scoring module 238 sets the overall score to 0% if the received message does not have any conditionals (i.e. all fields within the message are blank). Then in step 722, the scoring module 238 adds all of the filter scores, corresponding to the filtering criteria, and the statistical score. In step 724, this total is divided by the total number of filter and statistical scores, thus normalizing the overall score. For example, if the sending client has specified three filters within the filtering criteria, the three filters are given 75% of the overall score, and 25% of the overall score is based on the statistical score.

In an alternate embodiment however, the sending client can XML encode a custom method for generating the overall score, such as by specifying weights to be assigned conditionals, or by performing logical operations on the filtering and statistical scores themselves. For example, in the first case, the sending client can require that the fuzzy conditional comprises 75% of the overall score, while all of the quasi-Boolean conditionals only account for 25% of the overall score. In the second case, the sending client can require that a first filter score AND a second filter score NOT be above a predetermined score. Such logical operands (i.e. AND, NOT, etc.) can be useful disseminating message information to receiving clients who may not yet be aware of the information, and thus who would otherwise have scored low.

In other alternate embodiments, hierarchical rules may be encoded by the sending client into the message which specify different ways of calculating the overall score, depending upon scores assigned to one or more filtering and/or statistical conditionals.

After normalization, if each of the conditional scores are between “0” and “1,” then the overall score is similarly normalized to between “0” and “1.” Then in step 724, the scoring module 238 converts this normalized overall score to a percentage for display to the receiving client.

Thus the filtering and scoring methodologies presented, coupled with the private client profiles and the profile-richness that implies, allows users to define “expertise” in a way which is uniquely personal to that user.

While the above filtering and scoring discussion assumes the message was received over the peer-to-peer network 226, messages received over the e-mail network 222 as well as by other paths within the network 206 are similarly filtered and scored if the receiving client has the present invention's software installed.

Message Display and Response

In step 312, the received message is displayed to the receiving client preferably only if the message score exceeds a predetermined threshold. Messages are preferably displayed to the receiving client according to their respective score. As discussed above, the score represents a likelihood that the receiving client will find the message relevant to or within their expertise.

The receiving client then may select and respond to one of the messages. In step 314 a message response from the receiving client is sent over the network 206 back to the sending client anonymously or in an encrypted format. After step 314 the preferred method ends.

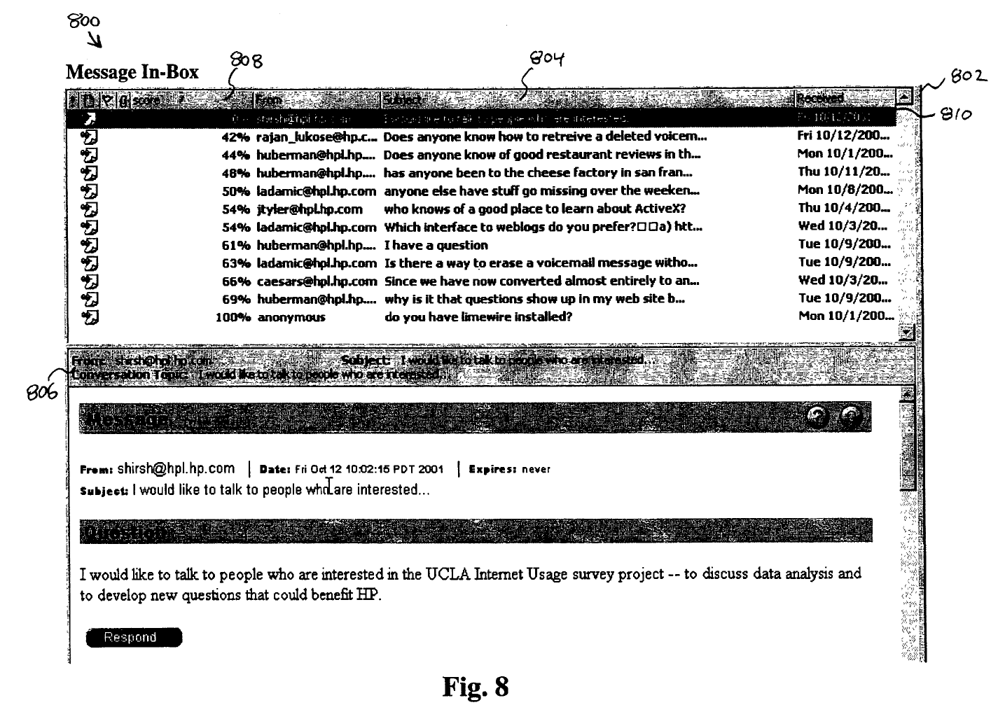

FIG. 8 is a pictorial diagram 800 of one embodiment of a “Messages InBox” window 802 within the system 200. The in-box window 802 is displayed by the user interface module 228 to the user 204. Depending upon how the user 204 has configured the user interface module 228, the in-box window 802 will be displayed either in an e-mail format by the e-mail client 230 or in an HTML format by the internet client 232. Both formats preferably provide similar functionality. The in-box window 802 includes a received messages portion 804 and a message viewing portion 806. Within the received messages portion 804 each message can be sorted by its score within a score field 808. As discussed above, the score represents a likelihood that the user 204 will find the message relevant to or within the expertise of the user 204.

The user 204 preferably can configure the in-box window 802 to display within the messages portion 804 messages having a score which exceeds a predetermined threshold. Thus in step 312, the received message is displayed to the user 204 if the message has not been filtered out and/or if the message score exceeds the predetermined threshold.

Preferably the user 204 is permitted to replace the score field 808 with a flag field so that relevant messages which exceed the predetermined threshold can be “flagged.” Alternatively, the user interface module 228 may be configured to present messages to the user 204 by a pop-up dialog window even when the user 204 is currently using a different application program on the client computer 202. Those skilled in the art will know of other ways of presenting messages to the user 204.

After the user 204 selects one of the messages 810, the selected message 810 is preferably displayed within the message viewing portion 806 of the in-box window 802. The message viewing portion 806 preferably includes a respond button 812.

Processing Information from Other Sources Using the Present Invention

While the present invention has been discussed with respect to the generation, transmission and response to messages, the present inventions' scoring functionality is equally applicable toward processing other types of information as well. Other information includes data displayed within a current web page being viewed by the user 204. A relevance vector could be generated from said web page data and compared to the user's 204 expertise vector generated from the client profile 210. User's would be notified of a particular relevance of the currently viewed web page if the relevance and expertise vectors when compared yield a score which exceeds a predetermined threshold. In this way user's browsing the web could be apprised of particular web pages which may closely align with their interests and/or expertise.

Other information similarly processed and scored may include: normal e-mail messages which have not been generated using the present inventions' functionality; files downloaded from the central server 224 or received from some other source; or expertise information stored on a central enterprise database. Those skilled in the art will know of other information sources to which the present invention may also be successfully applied.

While one or more embodiments of the present invention have been described, those skilled in the art will recognize that various modifications may be made. Variations upon and modifications to these embodiments are provided by the present invention, which is limited only by the following claims.

What is claimed is:

1. A method for knowledge management, comprising:
generating a message including a set of data items within a message field;
transmitting the message from a sending client to a set of receiving clients;
generating a receiving client profile on one of the receiving clients;
extracting the data items from the profile; and
scoring the data items in the message with respect to the data items in the profile.

2. The method of claim 1 wherein the set of data items are keywords.

3. The method of claim 1 wherein the set of data items are key-phrases.

4. The method of claim 1 wherein the set of data items are structured data items.

5. The method of claim 1 wherein the set of data items are unstructured data items.

6. The method of claim 1 wherein the scoring element further including:
generating a first expertise vector for a data item in the message;
generating a second expertise vector for a data item in the profile; and
comparing the first and second expertise vectors.

7. The method of claim 6 wherein generating the first and second expertise vector elements include generating the first and second expertise vectors using information retrieval techniques.

8. The method of claim 1 wherein the scoring element further including:
generating a first expertise vector magnitude equal to a relative term frequency of the data item in the message;
generating a first expertise vector magnitude equal to a relative term frequency of the data item in the profile; and
comparing the first and second expertise vector magnitudes.

9. The method of claim 1 wherein
the generating a receiving client profile element includes indexing data targets within the profile; and
the scoring element includes totaling the number of indexed data targets containing at least one occurrence of the data item.

10. The method of claim 1 wherein the generating a message element includes generating a message, having a set of filtering criteria.

11. The method of claim 10 wherein the generating a message element further includes including a structured data item into the filtering criteria.

12. The method of claim 10 wherein the generating a message element further includes including an unstructured data item into the filtering criteria.

13. The method of claim 10 wherein the generating a message element further includes including a behavioral data item into the filtering criteria.

14. The method of claim 10 wherein the generating a message element further includes requiring that a data item within the filtering criteria be found within a self-declared portion of the profile.

15. The method of claim 10 wherein the generating a message element further includes requiring that a data item within the filtering criteria be found within a URL portion of the profile.

16. The method of claim 10 wherein the generating a message element further includes requiring that a data item within the filtering criteria be found within an installed software portion of the profile.

17. The method of claim 10 wherein the generating a message element further includes requiring that a data item within the filtering criteria be found within an e-mail address portion of the profile.

18. The method of claim 10 wherein the scoring element further includes
assigning a first filter score to a filtering criteria within the set, if that filtering criteria within the set is found within the profile; and
assigning a second filter score to that filtering criteria within the set, if that filtering criteria is not found within the profile.

19. The method of claim 8 wherein the scoring element further includes:
assigning a first filter score to a filtering criteria within the set, if that filtering criteria within the set is found within the profile;
assigning a second filter score to that filtering criteria within the set, if that filtering criteria is not found within the profile; and
calculating an overall score from the expertise vectors and the filter scores.

20. The method of claim 19, wherein:
the generating element includes generating a message including a set of hierarchical rules for calculating the overall score; and
the calculating element includes calculating the overall score according to the hierarchical rules.

21. The method of claim 19, wherein:
the generating element includes generating a message including a set of logical rules for calculating the overall score; and
the calculating element includes calculating the overall score according to the logical rules.

22. A method for knowledge management, comprising:
generating a receiving client profile on at a receiving client;
storing the profile on the computer;
receiving a message including a set of data items within a message field;
extracting the data items from the profile; and
scoring the data items in the message with respect to the data items in the profile.

23. The method of claim 22 wherein the scoring element further including:
generating a first expertise vector for a data item in the message;
generating a second expertise vector for a data item in the profile; and
comparing the first and second expertise vectors.

24. The method of claim 23 wherein
the generating a message element includes generating a message, having a set of filtering criteria; and
the scoring element further includes,
assigning a first filter score to a filtering criteria within the set, if that filtering criteria within the set is found within the profile;
assigning a second filter score to that filtering criteria within the set, if that filtering criteria is not found within the profile; and
calculating an overall score from the expertise vectors and the filter scores.

25. A system for knowledge management, comprising:
means for generating a message including a set of data items within a message field;
means for transmitting the message from a sending client to a set of receiving clients;
means for generating a receiving client profile on one of the receiving clients;
means for extracting the data items from the profile; and
means for scoring the data items in the message with respect to the data items in the profile.

26. A system for knowledge management, comprising:
means for generating a receiving client profile on at a receiving client;
means for storing the profile on the computer;
means for receiving a message including a set of data items within a message field;
means for extracting the data items from the profile; and
means for scoring the data items in the message with respect to the data items in the profile.
